(19) United States
(12) Patent Application Publication
(10) Pub. No.: US 2005/0168619 A1
(43) Pub. Date: Aug. 4, 2005

(54) Light transmitting operating member

(76) Inventor: Yoichi Osada, Yokohama-shi (JP)

Correspondence Address: COWAN LIEBOWITZ & LATMAN P.C.;JOHN J TORRENTE, 1133 AVE OF THE AMERICAS, 1133 AVE OF THE AMERICAS, NEW YORK, NY, 10036, US

(21) Appl. No.: 11/047,034

(22) Filed: Jan. 31, 2005

(30) Foreign Application Priority Data
Feb. 3, 2004 (JP) 2004-026920(PAT.)

(51) Int. Cl. H04N 5/225

(52) U.S. Cl. 348/335

(57) ABSTRACT

A light transmitting operating member includes a first member having a first transmittance, a second member having a second transmittance greater than the first transmittance, wherein the first member has such a shape that the second member can be inserted into the first member, and the first member includes a compression member for pressing a switch member, and wherein the second member is inserted into the first member.

### BACKGROUND OF THE INVENTION

The present invention relates to a light transmitting operating member, and an optical apparatus that includes the same, such as a camera.

### RELATED ART

One conventional electronic apparatus arranges a light source on a back surface side etc. of an operating button and introduces the light from the light source to the outside of the apparatus via the operating button for decoration purposes of the apparatus and for guiding the operating method/procedure (see, for example, Japanese Patent Application, Publication No. 2002-216567, paragraph nos. 0014 and 0018 and FIG. 4). The two-color molding is generally used to form plural areas having difference colors and materials on an outer (or operating) surface of the operating button.

However, use of the two-color molding to form plural areas on the outer surface of the operating button has the following problems: For example, in order to coat a light shielding area on the operating button, the masking that prevents the coating material from covering the light transmitting area is formed and then removed, or all the outer surface of the operating button is coated and then coating on the light transmitting area is removed using the laser beam.

It is arduous to remove the masking and coating that are once formed.

### BRIEF SUMMARY OF THE INVENTION

Accordingly, it is an exemplary object of the present invention to provide a light transmitting operating member and an electronic apparatus having the same.

A light transmitting operating member according to one aspect of the present invention includes a first member having a first transmittance, a second member having a second transmittance greater than the first transmittance, wherein the first member has such a shape that the second member can be inserted into the first member, and the first member includes a compression member for pressing a switch member, and wherein the second member is inserted into the first member.

An electronic apparatus according to one aspect of the present invention includes a control circuit for control actions, a switch member, a light transmitting operating member that includes a first member having a first transmittance, a second member having a second transmittance greater than the first transmittance, wherein the first member has such a shape that the second member can be inserted into the first member, and the first member includes a compression member for pressing a switch member, and wherein the second member is inserted into the first member, and a light source provided inside the second member, wherein the switch member generates an electric signal when the compression member presses the switch member in accordance with an operation of the light transmitting operating member, wherein a surface of part of the first member and a surface of part of the second member in the light transmitting operating member expose from an opening in a sheath of the electronic apparatus.

Other objects and further features of the present invention will become readily apparent from the following description of the preferred embodiments with reference to the accompanying drawings.

### BRIEF DESCRIPTION OF THE DRAWINGS

FIG. 1 is a partially sectional and perspective view of an operating button according to a first embodiment of the present invention.

FIG. 2 is an exploded perspective view of the operating button according to the first embodiment.

FIG. 3 is a front perspective view of a digital camera having the operating button.

FIG. 4 is a rear perspective view of the digital camera having the operating button.

FIG. 5 is a sectional view of the operating button according to the first embodiment.

FIG. 6 is an assembly step of intermediate and outer buttons.

### DETAILED DESCRIPTION OF THE PREFERRED EMBODIMENTS

Referring to the accompanying drawings, a description will be given of the preferred embodiment.

### First Embodiment

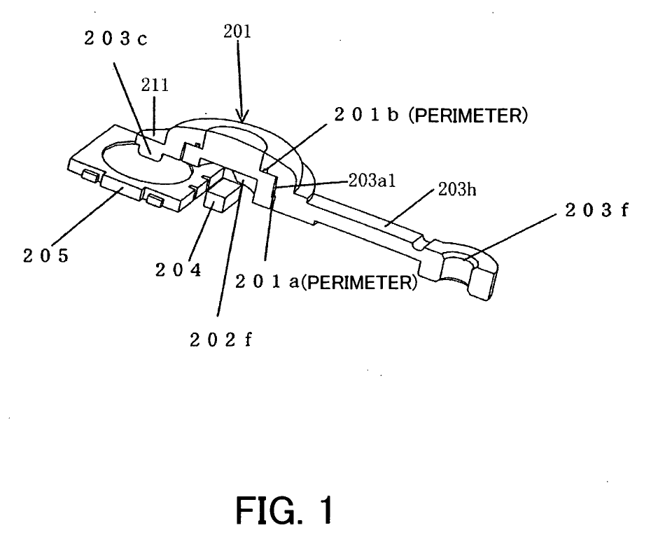

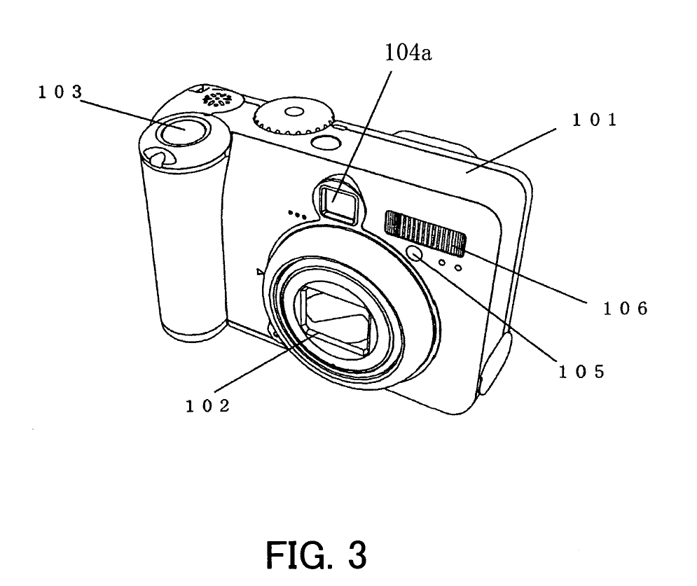

FIG. 3 is a first perspective view of a digital camera (as an electronic apparatus) having an operating button according to a first embodiment of the present invention. In FIG. 1, 101 denotes a camera body that includes various photographing components, such as an image pickup device (such as a CCD and a CMOS image sensor) for converting a optical image into image data through a photoelectric conversion, a low-pass filter, and a control circuit for controlling actions of the entire camera.

102 denotes a lens barrel having a photographing lens, which extends and retreats in the optical-axis direction to change a focal distance of an imaging optical system. 103 denotes a release button that activates a photographing ready action (i.e., a focus adjustment action and a light metering action) when half-pressed, and a photographing action (i.e., recording into a record carrier image data read out by an image pickup device) when fully pressed.

104a denotes an object-side window in a finder optical system, which enables a photographer to observe a subject image. 105 denotes a window of a light metering sensor that measures the subject's brightness or the light. The photometric result by the light metering sensor is sent to a control circuit in the camera body 101, and the control circuit operates an exposure value (such as a shutter speed and a stop value). 106 denotes a window of a strobo unit that irradiates the illumination light onto the subject.

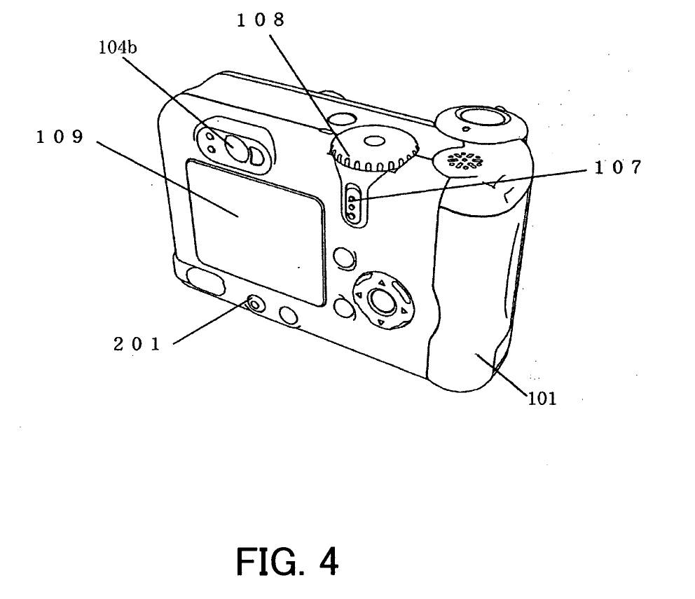

FIG. 4 shows a rear perspective view of the digital camera according to this embodiment. In FIG. 4, 104b denotes an eyepiece-side window in the finder optical system. 107 is a switching lever that switches a mode between a recording mode and a reproducing mode, and is attached to the camera body 101 slidably. When the switching lever 107 is operated to set the recording mode, the subject image is observed via the optical finder 104 or a liquid crystal display (“LCD”) unit 109 and photographed by pressing the release button 103.

When the switching lever 107 is operated to set the reproducing mode, image data recorded in the record carrier is displayed on the LCD unit 109.

108 denotes a mode dial, which switches various recording modes (such as an automatic recording mode, a stop priority AE mode, and a shutter speed priority AE mode) 109 denotes a LCD unit, which serves as an electronic view finder in the recording mode and display image data stored in the record carrier in the reproducing mode so as to enable a user to confirm the image. 201 denotes an operating button below the LCD unit 109.

The operating button 201 turns blue when external device, such as a printer (as an output device for outputting the image information on a paper) compatible with the digital camera is connected to the digital camera. An image of the digital camera is transferred to the printer by pressing this operating button 201.

Since the operating button turns blue while the digital camera is being connected to the printer, a user can immediately recognize that the digital camera is connected to the printer. In addition, the user does not press another button by mistake when transferring the image to the printer.

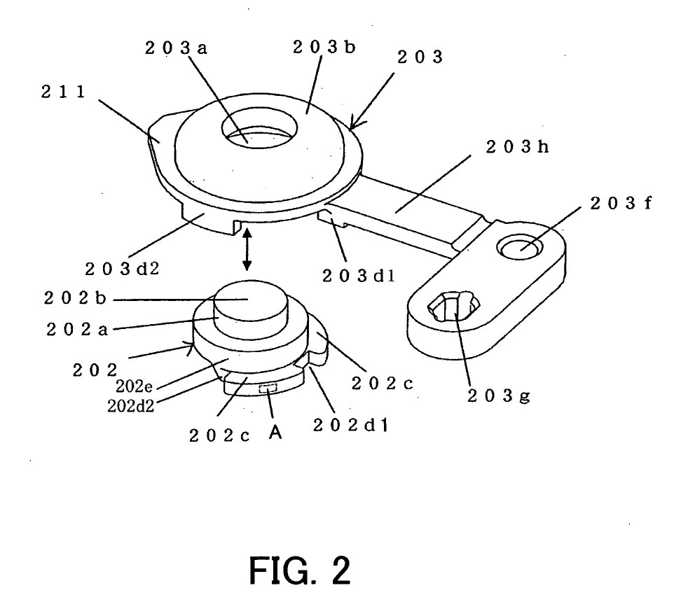

Primarily referring to FIGS. 1 and 2, a description will now be given of a structure of the operating button 201. The operating button 201 has a light transmitting inner button 202 (as a second member), and a light shielding outer button 203 (as a first member) having a transmittance of approximately zero.

The inner button 202 and outer button 203 are integrated into one member. The inner button 202 (or its protrusion 202a) is inserted into an insertion hole 203a in the outer button 203, and the inner button 202 and the outer button 203 are bonded together by the adhesive agent.

The adhesive agent that bonds the inner button 202 and the outer button 203 together is inserted into a space 201a defined by an outer circumference surface 202e on the inner button 202 and an inner circumference surface 203a1 of the insertion hole 203a in the outer button 203 (which opposes to the outer circumference surface 202e).

For tight bonding between the inner button 202 and the outer button 203, the adhesive agent must be filled in the space 201a that extends in the circumferential directions of the buttons 202 and 203. Therefore, this embodiment inclines or tapers the inner circumference surface 203a1 of the outer button 203, which increases its diameter from the inner side to the outer side (opposing to the outer surface of the operating button) of the outer button 203. In other words, the tapered surface 203a1 increases an interval between the inner circumference surface 203a1 and the outer circumference surface 202e from the inside to the outside of the operating button 201. This configuration makes the space 201a is wide at the insertion hole side for the adhesive agent and narrow in the interior side for the adhesive agent. As a result, the adhesive agent can be flowed on the inner circumference surface 203a1 and the outer circumference surface 202e entirely, and tightly bonds the inner button 202 and the outer button 203 together.

While this embodiment provides only the outer button 203 with the tapered surface 203a1, the outer circumference surface 202e of the inner button 202 may be provided with a tapered surface singularly or in combination with the tapered surface 203a1 because it is sufficient that the space 201a's shape is wide at the insertion hole for the adhesive agent and narrow in the interior for the adhesive agent.

In using the adhesive agent, it is necessary that the adhesive agent does not flow out through the contact portions between the inner button 202 and the outer button 203 to the outer surface of the operating button 201 (or outer surfaces 202b and 203b of the buttons 202 and 203).

Therefore, this embodiment forms, as shown in FIG. 1, an overflow resistant groove 201b that extends in an operating direction (or squeezing direction) of the operating button 201, on a surface orthogonal to the operating direction in the insertion hole 203a. The outflow of the adhesive agent to the outer surface is prevented by allowing the extra adhesive agent to flow in the overflow resistant groove 201b. The overflow resistant groove 201b is formed in the entire circumferential direction of the insertion hole 203a.

The overflow resistant groove 201b may be provided only partially on the insertion hole 203a in the circumferential direction. Alternatively, a groove corresponding to the overflow resistant groove 201b may be provided only in the inner button 202 singularly or in combination with the overflow resistant groove 201b.

While this embodiment integrates the inner button 202 with the outer button 203 using the adhesive agent, an engagement part may be provided to each of the inner button 202 and the outer button 203 for the integration between them through the engagement of these engagement parts. The inner button 202 and the outer button 203 may be fused or integrated by other means.

This embodiment flattens the outer surface 202b of the inner button 202 and the outer surface 203b of the outer button 203 by defining one joint surface between the inner button 202 and the outer button 203 as a designed reference surface and setting the size this designed reference surface to the outer surfaces 203b and 202b.

This configuration can minimize problems that the only the inner button 202 (or its protrusion 202a) projects from the outer surface of the operating button 201 and only the inner button 202 (or outer surface 202b) retreats from the outer surface 203a of the outer button 203. Therefore, the outer surface of the operating button 201 looks well with a sense of unity similar to the two-color molding.

This embodiment forms the operating button 201 whose operating surface is partially coated by previously coating the outer surface 203b of the outer button, and by attaching the inner button 202 to the coated outer button 203. This method can save arduous tasks, unlike the two-color molding, such as masking an area that does not require coating and removing the mask after the coating, or peeling off the unnecessary coating portion using the laser beam. Saving this arduous task makes the manufacturing process of the operating button simple and inexpensive.

The outer button 203 has first and second reference holes 203f and 203g through which bosses that protrude from a sheath cover penetrates, and the outer button 203 is fixed to the sheath cover of the camera body 101 via the bosses. Here, the first reference hole 203f positions the outer button 203 relative to the sheath cover. The second reference hole 203g determines a rotational angle, and enables the outer button 203 to be attached to the sheath cover at a predetermined position.

FIG. 1 arranges a light emitting diode (“LED”) 204 as a light source on the rear surface of the operating button 201 (opposing to its outer surface). The LED 204 is arranged approximately below the center of the outer surface of the operating button 201. A boss 203c (as a compression member) that contacts a tact switch 205 is formed on a flange portion 211 that extend more outwardly than the outer surface 203b in the radial direction. This LED turns blue when an external device, such as a printer, is connected to this digital camera via a cable, etc.

The LED 204 and the boss 203c provided outside the inner button 202 prevent the boss 203c from shielding the light from the LED 204 and from causing the uneven brightness, and spread the light from the LED 204 over the entire inner button 202. This configuration maintains the sufficient light intensity, and efficiently emits the light from the outer surface 202b of the inner button 202 to the outside.

Conceivably, the light tint or concentration of the inner button 202 makes the LED 204 and wiring board in the camera body 101 visible from the outside via the inner button 202. The enhanced diffusing power of the inner button 202 would eliminate problem that the LED 204 and wiring board in the camera body 101 etc. are visible from the outside.

When the inner button 202 has such a dark color that none of the wiring board etc. are visible from the outside, the light intensity of the light emitted from the operating button 201 to the outside might reduce. However, this embodiment arranges the LED 204 approximately below the center of the outer surface of the operating button 201, maximizes the light emitted from the LED 204, and maintains the sufficient light intensity of the light emitted from the LED 204.

It is possible to prevent the light intensity loss in the operating button 201 and to increase the brightness by planishing a surface of the insertion hole 203a of the outer button 203, coating the surface with a silver material having the high reflectance, and plating the surface, etc. The light intensity of the light emitted from the outer surface of the operating button 201 to the outside increases by the reduced light intensity loss.

An application of the same process to the surface of the insertion hole 203a and the outer surface 203b would simplify the processing to the operating button 201 (or outer button 203).

Changes of the luminescent color of the LED 204 and the current value that flows the LED 204 and use of different inner button 202 would provide various types of brightness and tints.

In this embodiment, when the user presses the operating button 201, the operating button 201 deforms at a hinge 203h of the outer button 203 and the boss 203c provided on the rear surface of the outer button 203 contacts the tact switch 205 mounted on the wiring board (not shown). Thereby, the tact switch 205 turns on, and this signal is sent to the control circuit in the camera body 101.

The rear surface of the inner button 202 (or a surface opposing to the outer surface 202b) has a concave 202f. Therefore, even when the operating button 201 is pressed, the inner button 202 does not contact the LED 204. In other words, the concave 202f provides an arrangement close to the operating button 201 (or the inner button 202), reduces the arrangement space around the operating button 201, and miniaturizes the camera.

When the user stops pressing the operating button 201, the operating button 201 promptly returns to the predetermined position (a pre-pressed position) due to the reaction by the hinge 203h of the outer button 203. At this time, when the boss 203c separates from the tact switch 205, the tact switch 205 turns off. Until the operating button 201 is pressed again, the tact switch 205 remains at the off state.

Since the operating button 205 has two components, i.e., the inner button 202 and the outer button 203, an excessive outer force applied to the operating button 201 might possibly disengage the inner button 202 from the outer button 203: Since the outer button 203 is fixed onto the sheath cover of the camera via the reference holes 203f and 203g and the inner button 202 is fixed onto the outer button 203 via the adhesive agent, an application of the external force to the inner button 202 could offset a joint position between the inner button 202 and the outer button 203.

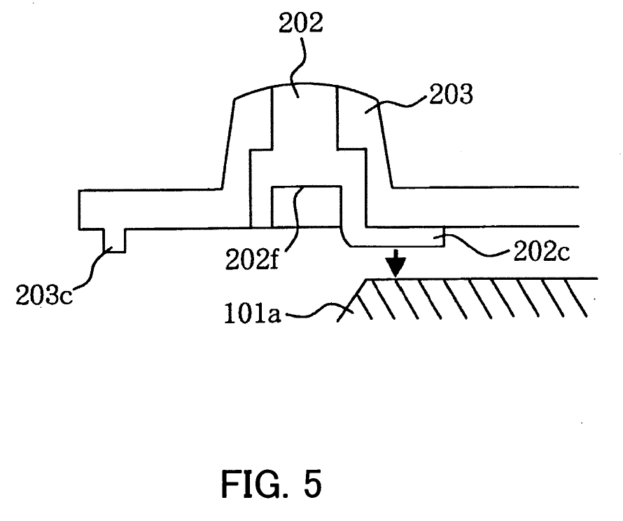

Accordingly, this embodiment forms a pair of legs 202c on the outer circumference surface of the inner button 202, each of which extends to the outside of the inner button 202 in a radial direction. The leg 202c (or the elongated part) contacts a chassis 101a provided in the camera body 101 (see FIG. 5). This configuration reduces the shearing stress at the joint part between the inner button 202 and the outer button 203, preventing an offset of the inner button 202 relative to the outer button 203.

In order to prevent the inner button 202 and the outer button 203 from being connected to each other at an offset state from the above predetermined phase, the inner button 202 and the outer button 203 should be incorporated while their phases are being matched. This embodiment engages legs 203d1 and 203d2 formed on the outer button 203 with positioners 202d1 and 202d2 formed on the inner button 202, and incorporates the inner button 202 with the outer button 203 at the above predetermined phase.

A description will now be given of the gate position in molding the inner button 202. As described above, the inner button 202 is made of a light transmitting material (such as resin), and is formed by flowing the resin into the specific mold from the gate. This embodiment provides the molding gate position on the outer surface of the leg 202c, as shown by a broken line A in FIG. 2, for the following reasons.

The molding gate position provided on the outer surface 202b of the inner button 202 causes the flashes etc. to be located on the outer surface 202b, which occur when the gate is removed. In this case, the flashes etc. causes the unevenness of the light emitted to the outside from the outer surface 202b and makes the outer surface of the operating button 201 look poor.

The molding gate position provided at the contact part between the intermediate position 202 and the insertion hole 203a in the outer button makes unstable the contact between the inner button 202 and the outer button 203 due to the flashes etc. that can occur during the gate process, and lowers the joint force between the inner button 202 and the outer button 203. Therefore, this embodiment provides the molding gate position on the outer surface of the leg 202c, which is a part that is located other than the outer surface 202b of the inner button 202 and other than the part that contacts the insertion hole 203c.

The inner button 202 and the outer button 203 can be integrated with each other before the gate processing of the inner button 202 by providing the gate position on the outer circumference surface of the leg 202c and forming a runner at a position that does not interferes with the outer button 203 when the outer button 203 is incorporated with the inner button 202. Use of the runner that is more easily handled than the inner button 202 and the outer button 203 to integrate the inner button 202 with the outer button 203 facilitates the assembly of the operating button 201.

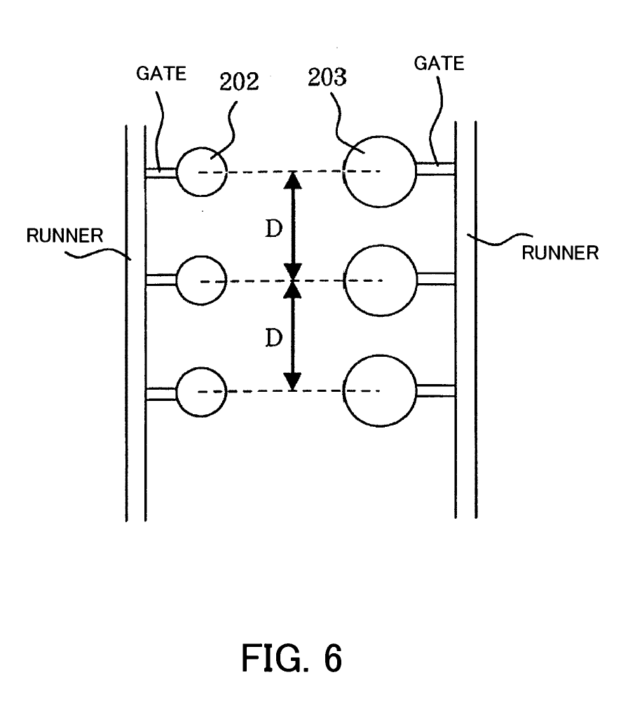

Simultaneous molding of plural inner buttons 202 facilitates an integration between the inner button 202 and the outer button 203 using the runner. When the inner button 202 and the outer button 203 have the corresponding intervals (D) can provide simultaneous molding of plural inner buttons 202 and plural outer buttons 203 as shown in FIG. 6 before the gate processing to the inner button 202 and the outer button 203, facilitating the assembly of the operating button 201.

A description will now be given of a variation of the first embodiment.

While the first embodiment arranges the light transmitting inner button 202 at the center of the operating button 201 and the light shielding outer button 203 (having the transmittance of approximately zero) around the inner button 202, the present invention is not limited to the configuration of the first embodiment.

For example, the material for the inner button 202 may be replaced with the material for the outer button 203. In other words, the inner button 202 shields the light from the LED 204 while the outer button 203 transmits the light. The inner button 202 and the outer button 203 transmit the light while their transmittances may differ from each other. For example, the transmittance of the inner button 202 may be higher or lower than the transmittance of the outer button 203.

The above variation can exhibit similar effects to those of the first embodiment.

While the above embodiment provides the operating button to the digital camera, the present invention is applicable, for example, to a portable game machine, remote controller, portable audio equipment, etc.

This application claims foreign priority benefits based on Japanese Patent Application No. 2004-026920, filed on Feb. 3, 2004, which is hereby incorporated by reference herein in its entirety as if fully set forth herein.

1. A light transmitting operating member comprising:
a first member having a first transmittance;
a second member having a second transmittance greater than the first transmittance,
wherein said first member has such a shape that said second member can be inserted into said first member, and said first member includes a compression member for pressing a switch member, and
wherein said second member is inserted into said first member.

2. A light transmitting operating member according to claim 1, wherein said first member has a reflective surface on an inner surface of said first member.

3. A light transmitting operating member according to claim 1, wherein the compression member is located on said first member at a side of a non-outer surface of said operating member and outside said operating member.

4. A light transmitting operating member according to claim 1, further comprising an adhesive agent at a side of a non-outer surface of said operating member and between an inner surface of said first member and an outer surface of said second surface,
wherein at least one of the inner surface of said first member and the outer surface of said second surface has a tapered surface that increases, as the tapered surface approaches to the non-outer surface of said operating member, a retreat amount from the other surface of the inner surface of said first member and the outer surface of said second surface.

5. A light transmitting operating member according to claim 1, further comprising:
an adhesive agent at a side of a non-outer surface of said operating member and between an inner surface of said first member and an outer surface of said second surface; and
a groove member for preventing an outflow of said adhesive agent to the outer surface of said operating member, said groove member being provided on at least one of the inner surface of said first member and the outer surface of said second surface, and closer to the outer surface of said operating member than a part where said adhesive agent is provided.

6. A light transmitting operating member according to claim 1, further comprising an elongation that is provided on said second member at a side of a non-outer surface of said operating member, and extends to the outside of the outer surface of said operating member,
wherein said elongation includes an engagement part that is engaged with said first member and positions said second member around an insertion direction axis along which said second member is inserted into said first member.

7. A light transmitting operating member according to claim 1, further comprising an elongation that is provided on said second member at a side of a non-outer surface of said operating member, and extends to the outside of the outer surface of said operating member,
wherein said elongation includes a contact surface that contacts a member different from said operating member when said operating member is pressed.

8. An electronic apparatus comprising:
a control circuit for control actions;
a switch member;
a light transmitting operating member that includes a first member having a first transmittance, a second member having a second transmittance greater than the first transmittance, wherein said first member has such a shape that said second member can be inserted into said first member, and said first member includes a compression member for pressing a switch member, and wherein said second member is inserted into said first member; and
a light source provided inside said second member;
wherein said switch member generates an electric signal when the compression member presses said switch member in accordance with an operation of said light transmitting operating member,
wherein a surface of part of said first member and a surface of part of said second member in said light transmitting operating member expose from an opening in a sheath of said electronic apparatus.

9. An electronic apparatus according to claim 8, wherein the compression member is provided on a surface of said first member at a rear side of a surface at a sheath side which does not expose from the opening.

10. An electronic apparatus according to claim 8, wherein said second member has a concave shape that opposes to a sheath side, and
wherein said light source is located inside the concave shape.

11. An electronic apparatus according to claim 8, wherein said light source turns on during a connection period during which an output device for outputting image information to a paper is connected to said electronic apparatus, and image information in said electronic apparatus is transferred to the output device when said light transmitting operating member is pressed during the connection period.
